(19) United States
(12) Patent Application Publication
(10) Pub. No.: US 2024/0202299 A1
(43) Pub. Date: Jun. 20, 2024

(54) METHOD FOR IDENTITY VERIFICATION

(71) Applicant: Industrial Technology Research Institute, Hsinchu (TW)

(72) Inventors: Wei-Chen LEE, New Taipei City (TW); Wei-Chieh LIN, Tainan City (TW); Jian-Ren CHEN, Hsinchu City (TW)

(21) Appl. No.: 18/085,057

(22) Filed: Dec. 20, 2022

(51) Int. Cl. G06F 21/32; G06T 5/50; G06V 40/12; G06V 40/16; G10L 17/00

(52) U.S. Cl. CPC G06F 21/32; G06T 5/50; G06V 40/12; G06V 40/168; G10L 17/00; G06T 2207/20221; G06T 2207/30201

(57) ABSTRACT

A method for identity verification is provided. At least some initial low-sensitivity information about a person is stored in a database. The method includes the following stages. The identity of the person is obtained. The initial low-sensitivity information associated with the person is searched for in the database based on the identity of the person. Biological signal data from the person are obtained according to the data category of the initial low-sensitivity information associated with the person. The biological signal data from the person are sampled and dimension reduction is performed to generate real-time low-sensitivity information associated with the person. The data category and a data form for comparing the real-time low-sensitivity information with the initial low-sensitivity information are determined. The real-time low-sensitivity information and the initial low-sensitivity information corresponding to the data category and the data form are displayed graphically.

### BACKGROUND

### Technical Field

The present disclosure relates to a method for identity verification, and, in particular, to a method for identity verification using low-sensitivity information for identification.

### Prior Art

Before providing medical care to individuals, the healthcare workers in long-term care bases or community-care institutions need to verify the identity of each patient (by, for example, checking ID cards or registration) before the patient can apply for long-term care subsidies or institutional subsidies. Therefore, it is very important for the field whether the case information is correctly assigned to the healthcare center.

In the prior art, if the user does not carry an identity document, the healthcare workers cannot confirm the identity of the personnel. There being a large number of people in the field can easily cause problems such as false identifications, wrong filings, and false head counts. The equipment in the field cannot directly use complete biological data for personnel confirmation in these cases (for example, a complete image or voiceprint data), as this may raise concerns about violating personal privacy.

### BRIEF SUMMARY

An embodiment of the present disclosure provides a method for identity verification. At least some initial low-sensitivity information about a person is stored in a database. The method includes the following stages. The identity of the person is obtained. The initial low-sensitivity information associated with the person is searched for in the database based on the identity of the person. Biological signal data from the person are obtained according to the data category of the initial low-sensitivity information associated with the person. The biological signal data from the person are sampled and dimension reduction is performed to generate real-time low-sensitivity information associated with the person. The data category and a data form for comparing the real-time low-sensitivity information with the initial low-sensitivity information are determined. The real-time low-sensitivity information and the initial low-sensitivity information corresponding to the data category and the data form are displayed in graphical form.

According to the method as described above, further includes the following stages. A candidate list for matching the identity of the person is obtained. A control signal is received to select the person from the candidate list.

According to the method as described above, further includes the following stages. A control signal is received to confirm that the real-time low-sensitivity information matches the initial low-sensitivity information.

According to the method as described above, the data category includes face images, voiceprints, palm prints, and handwriting.

According to the method as described above, when the data category is face images, the step of sampling and performing dimension reduction on the biological signal data from the person includes the following stages. A facial feature detector is utilized to capture multiple feature points in the face images. Cutting is carried out according to the distribution of the feature points. A portion of the feature points corresponding to a part of the face are left. The part of the face in a face image and the portion of the feature points corresponding to a part of the face are captured and stored.

According to the method as described above, when the data category is voiceprints, the step of sampling and performing dimension reduction on the biological signal data from the person includes the following stages. A microphone is utilized to receive an audio signal from the person. A Fourier transform is performed on the audio signal to obtain an audio spectrum. The logarithm of the audio spectrum is taken and an inverse Fourier transform is performed on the audio spectrum to generate a Mel-spectrogram. A portion of spectrum information in the Mel-spectrogram is captured and stored.

According to the method as described above, the data form includes translucent overlapping, vertically cropped image stitching, and horizontally cropped image stitching.

According to the method as described above, when the data category is handwriting, the method further includes the following stage. The translucent overlapping is performed on the real-time low-sensitivity information and the initial low-sensitivity information.

According to the method as described above, when the data category is face images, the method further includes the following stage. The vertically cropped image stitching is performed on the real-time low-sensitivity information and the initial low-sensitivity information.

### BRIEF DESCRIPTION OF DRAWINGS

FIG. 1 is a flow chart of a method for identity verification in accordance with some embodiments of the present disclosure.

FIG. 2 is a detailed flow chart of the data category being face images in step S106 in FIG. 1 in accordance with some embodiments of the present disclosure.

FIG. 3 is a schematic diagram of the detail flow chart in FIG. 2 in accordance with some embodiments of the present disclosure.

FIG. 4 is a detailed flow chart of the data category being voiceprints in step S106 in FIG. 1 in accordance with some embodiments of the present disclosure.

FIG. 5 is a schematic diagram of the detail flow chart in FIG. 4 in accordance with some embodiments of the present disclosure.

FIG. 6 is a schematic diagram of the data category being handwriting in step S108 and step S110 in FIG. 1 in accordance with some embodiments of the present disclosure.

FIG. 7 is a schematic diagram of the data category being face images in step S108 and step S110 in FIG. 1 in accordance with some embodiments of the present disclosure.

FIG. 8 is a schematic diagram of the data category being voiceprints in step S108 and step S110 in FIG. 1 in accordance with some embodiments of the present disclosure.

FIG. 9 is a schematic diagram of a user interface 900 in accordance with some embodiments of the present disclosure.

### DETAILED DESCRIPTION

Reference may now be made in detail to the exemplary embodiments of the present disclosure, examples of which are illustrated in the accompanying drawing. Wherever possible, the same reference numbers are used in the drawings and descriptions to refer to the same or like parts.

Certain terms may be used throughout the present specification and appended claims to refer to particular element. Those skilled in the art should understand that electronic device manufacturers may refer to the same component by different names. This article does not intend to distinguish between those components that have the same function but have different names. In the following description and claims, words such as “including” and “comprising” are open-ended words, so they should be interpreted as meaning “including but not limited to . . . ”.

The directional terms mentioned herein, such as: “upper”, “lower”, “front”, “rear”, “left”, “right” etc., are only the directions of the reference drawings. Accordingly, the directional terms used are illustrative, not limiting, of the disclosure. In the drawings, each figure illustrates the general features of methods, structure and/or materials used in a particular embodiment. However, these drawings should not be interpreted as defining or limiting the scope or nature encompassed by these embodiments. For example, the relative sizes, thicknesses and positions of layers, regions and/or structures may be reduced or exaggerated for clarity.

One structure (or layer, component, substrate) described in the present disclosure is located on/over another structure (or layer, component, substrate), which may mean that the two structures are adjacent and directly connected, or the two structures are adjacent but indirectly connected. Indirect connection means that there is at least one intermediary structure (or intermediary layer, intermediary component, intermediary substrate, intermediary interval) between two structures. The lower surface of one structure is adjacent to or directly connected to the upper surface of the intermediary structure, and the upper surface of the other structure is adjacent to or directly connected to the lower surface of the intermediary structure. The intermediary structure can be composed of a single-layer or multi-layer physical structure or a non-physical structure without limitation. In the present disclosure, when a certain structure is set “on” other structures, it may mean that a certain structure is “directly” on other structures, or that a certain structure is “indirectly” on other structures, that is, between a certain structure and other structures. At least one structure is also interposed.

The terms “about”, “equal”, “same”, or “substantially” are generally interpreted as within 20% of a given value or range, or as within 10%, 5%, 3%, 2%, 1% or 0.5% of a given value or range. The ordinal numbers used in the specification and claims, such as “first”, “second”, etc., are used to modify elements, which do not imply and represent any previous ordinal number of the (or those) elements, nor does it imply the order of one element with another, or the order in the method of manufacture. These ordinal numbers are used only to clearly distinguish an element with a certain designation from another element with the same designation. The claims and the description may not use the same term, accordingly, the first component in the description may be the second component in the claim.

The electrical connection or coupling described in the present disclosure can refer to direct connection or indirect connection. In the case of direct connection, the terminals of the components on the two circuits are directly connected or connected to each other by a conductor line segment. In the case of indirect connection, there are switches, diodes, capacitors, inductors, resistors, other suitable components, or a combination of the above components between the terminals of the components on the two circuits, but not limited thereto.

In the present disclosure, the thickness, length and width can be measured by an optical microscope, and the thickness or width can be measured by a cross-sectional image in an electron microscope, but not limited thereto. In addition, any two values or directions used for comparison may have certain errors. In addition, the terms “equal to”, “equal”, “same”, or “substantially” mentioned in the present disclosure generally mean falling within 10% of a given value or range. In addition, the words “the given range is the first value to the second value”, “the given range falls within the range of the first value to the second value” indicate that the given range includes the first value, the second value and other values there between. If the first direction is perpendicular to the second direction, the angle between the first direction and the second direction may be between 80 degrees and 100 degrees. If the first direction is parallel to the second direction, the angle between the first direction and the second direction may be between 0 degrees and 10 degrees.

It should be noted that, in the following embodiments, without departing from the spirit of the present disclosure, features in several different embodiments may be replaced, reorganized, and mixed to complete other embodiments. As long as the features of the various embodiments do not violate the spirit of the disclosure or conflict, they can be mixed and matched arbitrarily.

Unless otherwise defined, all terms (including technical and scientific terms) used herein have the same meaning as commonly understood by one of ordinary skill in the art to which this disclosure belongs. It can be understood that these terms, such as those defined in commonly used dictionaries, should be interpreted as having a meaning consistent with the background or context of the related art and the present disclosure. Rather, it should not be interpreted in an idealized or overly formal manner, unless otherwise defined in the embodiments of the present disclosure.

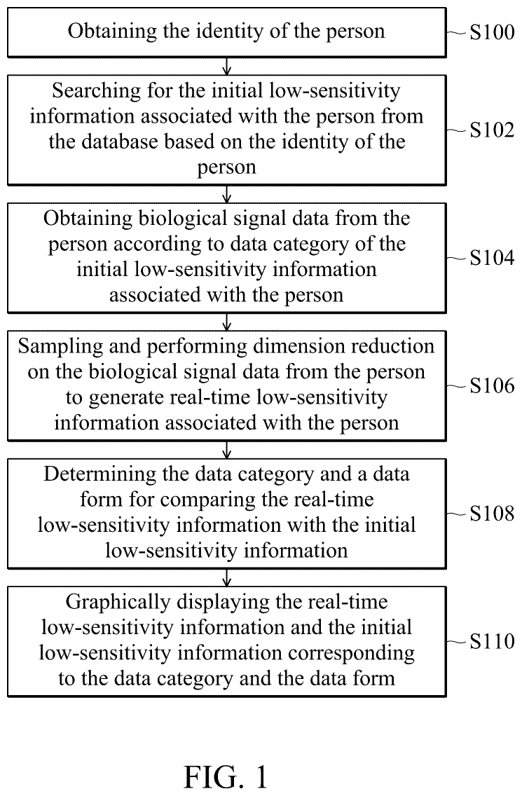

FIG. 1 is a flow chart of a method for identity verification in accordance with some embodiments of the present disclosure. As shown in FIG. 1, the method for identity verification of the present disclosure includes the following stages. The identity of the person is obtained (step S100). The initial low-sensitivity information associated with the person is sought from the database based on the identity of the person (step S102). Biological signal data from the person are obtained according to the data category of the initial low-sensitivity information associated with the person (step S104). The biological signal data from the person are sampled and dimension reduction is performed to generate real-time low-sensitivity information associated with the person (step S106). The data category and a data form for comparing the real-time low-sensitivity information with the initial low-sensitivity information are determined (step S108). The real-time low-sensitivity information and the initial low-sensitivity information corresponding to the data category and the data form are displayed in graphical form (step S110).

In some embodiments, steps S100 to S110 in FIG. 1 are performed by a processor in an electronic device controlling other components. The electronic device can be, for example, a desktop, a laptop, a tablet, a smart phone, and a server, but the present disclosure is not limited thereto. For example, in step S100, the processor obtains the identity of the person through an input device. The input device may be, for example, a card reader, a keyboard, etc., but the present disclosure is not limited thereto. In step S102, the processor can connect to the database through the Internet to search for at least one initial low-sensitivity information associated with the person. In step S104, the processor obtains the biological signal data from the person from different other devices (such as a camera, a palm reader, a handwriting tablet, a radio, etc.) according to the data category of the initial low-sensitivity information. The processor of the electronic device of the present disclosure directly performs steps S106 and S108. In step S110, the processor controls a display to graphically display the real-time low-sensitivity information and the initial low-sensitivity information associated with the person.

In step S100, the identity of the person can be, for example, the last 3 digits of the person's ID card number, the last name, or the last 3 digits of the mobile phone number, but the present disclosure is not limited thereto. In step S102, for example, the present disclosure obtains in step S100 that the last 3 digits of the ID card number of the person are XXX, then the present disclosure searches for all persons whose last 3 digits of the ID card number is XXX from the database and their corresponding initial low-sensitivity information. In some embodiments, in step S100 of the present disclosure, the person whose last name is “Li” is obtained, and in step S102, the present disclosure searches the database for all persons whose last name is Li and their corresponding initial low-sensitivity information. In some embodiments, in step S100, the present disclosure obtains that the last 3 digits of the mobile phone number of the person is YYY, and then in step S102, the present disclosure searches for all persons whose last 3 digits of mobile phone number is YYY and their corresponding initial low-sensitivity information.

In some embodiments of step S102, the present disclosure obtains a candidate list for matching the identity of the person. Afterwards, the present disclosure receives a control signal through a user interface to select the person from the candidate list. For example, if the present disclosure obtains in step S100 that the last 3 digits of the ID card numbers of the person are XXX, the present disclosure obtains a candidate list including all persons whose last 3 digits of ID card numbers is XXX. Then, the present disclosure receives the control signal through the user interface to select the correct person from the candidate list. In some embodiments, in step S100 of the present disclosure, the person whose last name is “Li” is obtained, and the present disclosure obtains a candidate list including all persons whose last name are “Li”. Then, the present disclosure receives a control signal through the user interface to select the correct person from the candidate list. In some embodiments, the present disclosure obtains in S100 that the last 3 digits of mobile phone number of the person are YYY, and then the present disclosure obtains a candidate list including all persons whose last 3 digits of mobile phone number are YYY. After that, the present disclosure receives a control signal through the user interface to select the correct person from the candidate list. In some embodiments, the user interface can be operated by a healthcare worker, but the disclosure is not limited thereto.

In step S104, The data category of the initial low-sensitivity information may be, for example, face images, voiceprints, palm prints, and handwriting, but the present disclosure is not limited thereto. For example, if the data category of the initial low-sensitivity information associated with the person found in step S102 is a face image, the present disclosure uses a facial feature detector (for example, a video camera or camera) to obtain the face image of the person. That is, the biological signal data from the person at this time is the face image. In some embodiments, if the data category of the initial low-sensitivity information associated with the person found in S102 is a voiceprint, the present disclosure uses a microphone or a tape recorder to obtain a voice signal of the person. That is, the biological signal data from the person at this time is the voice signal. In some embodiments, if the data category of the initial low-sensitivity information associated with the person found in S102 is a palm print, the present disclosure uses a palm print detection device to obtain the palm print data from the person. That is, the biological signal data from the person at this time is the palm print data. In some embodiments, if the data category of the initial low-sensitivity information associated with the person found in S102 is handwriting, the present disclosure uses a tablet to obtain the handwriting data from the person. That is, the biological signal data from the person at this time is the handwriting data.

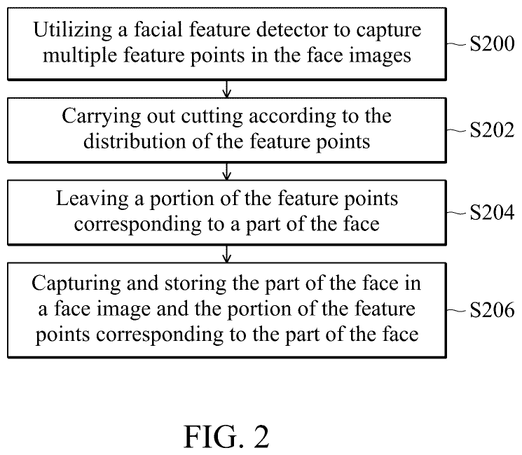

In step S106 of FIG. 1, the present disclosure captures and stores a portion of the collected biological signal data to reduce the sensitivity of information and protect the privacy of the person. FIG. 2 is a detailed flow chart of the data category being face images in step S106 in FIG. 1 in accordance with some embodiments of the present disclosure. As shown in FIG. 2, the method for identity verification of the present disclosure includes the following stages. A facial feature detector is utilized to capture multiple feature points in the face images (step 200). Cutting is carried out according to the distribution of the feature points (step 202). A portion of the feature points corresponding to a part of the face are left (step 204). The part of the face in a face image and the portion of the feature points corresponding to a part of the face are captured and stored (step S206). In step S200, the facial feature detector can be, for example, a video camera or a camera coupled with a facial recognition algorithm, but the disclosure is not limited thereto.

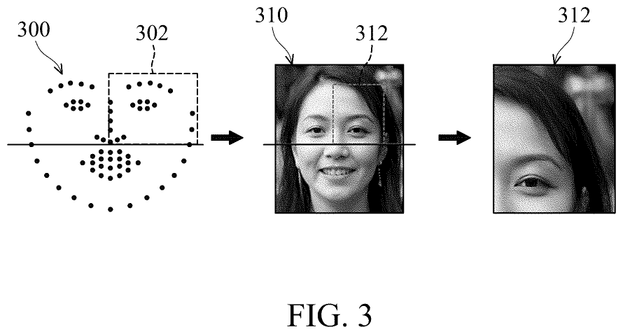

FIG. 3 is a schematic diagram of the detail flow chart in FIG. 2 in accordance with some embodiments of the present disclosure. The present disclosure captures multiple feature points 300 from the face image 310 in step S200. In step S202, the present disclosure carries out cutting according to the distribution of the feature points 300 to obtain a portion of feature points 302. In some embodiments, as shown in FIG. 3, the portion of feature points 302 correspond to a part of the face 312 in the face image 310. In step S204, the present disclosure leaves the portion of the feature points 302 and the part of the face 312. Then, in step S206, the present disclosure captures and stores the part of the face 312 in the face image 310 and the portion of the feature points 302 corresponding to the part of the face 312.

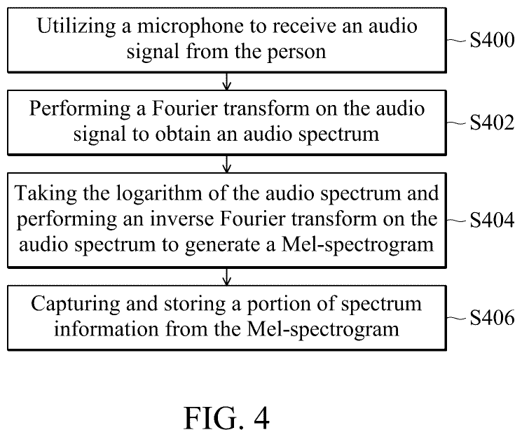

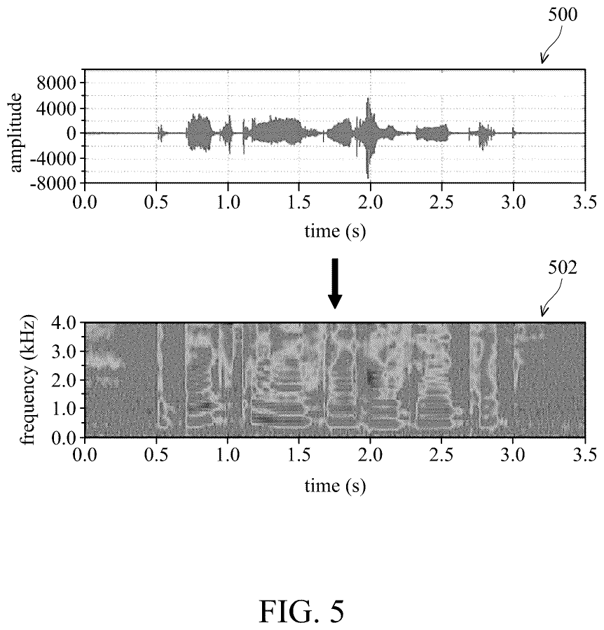

FIG. 4 is a detailed flow chart of the data category being voiceprints in step S106 in FIG. 1 in accordance with some embodiments of the present disclosure. As shown in FIG. 4, the method for identity verification of the present disclosure includes the following stages. A microphone is utilized to receive an audio signal from the person (step S400). A Fourier transform is performed on the audio signal to obtain an audio spectrum (step S402). The logarithm of the audio spectrum is taken and an inverse Fourier transform is performed on the audio spectrum to generate a Mel-spectrogram (step S404). A portion of spectrum information in the Mel-spectrogram is captured and stored (step S406). In some embodiments, the present disclosure also uses a radio to receive and store the voice signal of the person, but the present disclosure is not limited thereto. FIG. 5 is a schematic diagram of the detail flow chart in FIG. 4 in accordance with some embodiments of the present disclosure. Please refer to FIG. 4 and FIG. 5 at the same time. In step S400, the present disclosure uses a microphone to receive a voice signal 500 of the person. In step S402, the present disclosure performs a Fourier transform on the audio signal 500 to obtain an audio spectrum (not shown). After that, in step S404, the present disclosure takes the logarithm of the audio spectrum, and performs an inverse Fourier transform on the audio spectrum to generate a Mel-spectrogram 502. Then, in step S406, the present disclosure captures and stores a portion of spectrum information in the Mel-spectrogram 502 for subsequent comparison.

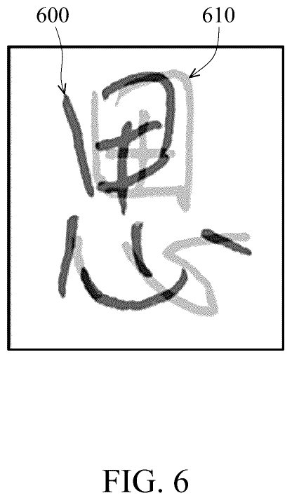

FIG. 6 is a schematic diagram of the data category being handwriting in step S108 and step S110 in FIG. 1 in accordance with some embodiments of the present disclosure. In some embodiments of FIG. 6, the data category of the initial low-sensitivity information is handwriting. For example, in FIG. 6, the initial low-sensitivity information is handwriting 610, and the present disclosure uses a handwriting tablet to obtain the biological signal data from the person, such as handwriting 600. If the initial low-sensitivity information and biological signal data from the person are both handwriting (for example, handwriting 610 and handwriting 600 respectively), the method for identity verification of the present disclosure performs the translucent overlapping (being the data form in the step S108) in FIG. 6 on handwriting 600 and handwriting 610 for subsequently comparing whether the handwriting 600 match with the handwriting 610. In some embodiments, in step S110, the present disclosure displays the translucent overlapping images of the handwriting 600 and the handwriting 610 in FIG. 6 in a user interface for comparison and confirmation by the healthcare worker.

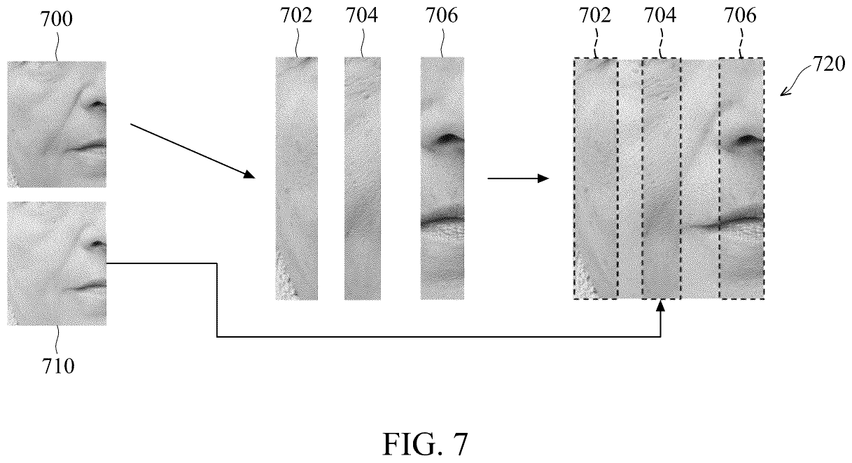

FIG. 7 is a schematic diagram of the data category being face images in step S108 and step S110 in FIG. 1 in accordance with some embodiments of the present disclosure. In some embodiments of FIG. 7, the data category of the initial low-sensitivity information is a face image. For example, the initial low-sensitivity information in FIG. 7 is a face image 710, and the present disclosure uses a facial feature detector (such as a video camera or camera) to obtain the biological signal data from the person, such as the face image 700. If the initial low-sensitivity information and biological signal data from the person are both face images (for example, the face image 710 and the face image 700 respectively), the method for identity verification of the present disclosure performs vertical cropping image stitching on the face image 700 and the face image 710. In detail, as shown in FIG. 7, the method for identity verification of the present disclosure first captures three image segments from the face image 700, such as an image segment 702, an image segment 704, and an image segment 706. In some embodiments, the image segment 702, the image segment 704, and the image segment 706 are mutually discontinuous image segments in the face image 700, but the present disclosure is not limited thereto. Then, the method for identity verification of the present disclosure stitches the image segment 702, the image segment 704, and the image segment 706 from the face image 700 on corresponding positions of the face image 710 to generate a stitched face image 720. After that, the method for identity verification of the present disclosure displays the stitched face image 720 on a user interface for comparison and confirmation by the healthcare worker.

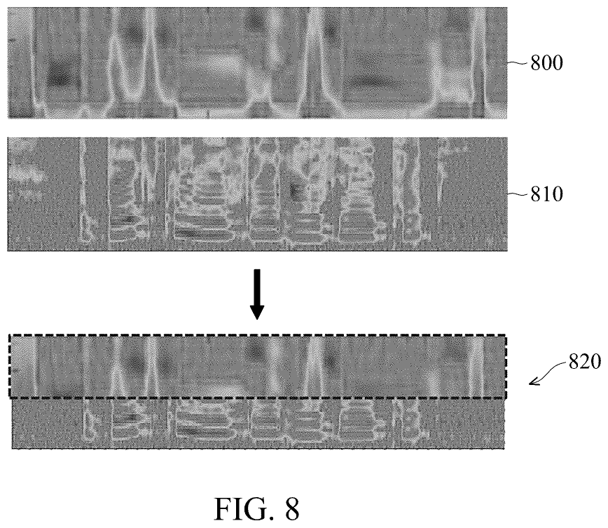

FIG. 8 is a schematic diagram of the data category being voiceprints in step S108 and step S110 in FIG. 1 in accordance with some embodiments of the present disclosure. In some embodiments of FIG. 8, the data category of the initial low-sensitivity information is a voiceprint. For example, the initial low-sensitivity information in FIG. 8 is a Mel-spectrogram 810, then the present disclosure uses a microphone or a radio to obtain the biological signal data from the person, such as an audio signal. If the initial low-sensitivity information and biological signal data from the personnel are all information related to audio (for example, the Mel-spectrogram 810 and the audio signal respectively), then the method for identity verification of the present disclosure performs vertically cropped image stitching on the Mel-spectrogram 810 and the Mel-spectrogram 800 based on the audio signal. In detail, the method for identity verification of the present disclosure performs a Fourier transform on the audio signal from the person to obtain an audio spectrum. The method for identity verification of the present disclosure takes the logarithm of the audio spectrum and performs an inverse Fourier transform on the audio spectrum to generate the Mel-spectrogram 800. In some embodiments of FIG. 8, the method for identity verification of the present disclosure captures the upper half of the Mel-spectrogram 800, and stitches the upper half of the Mel-spectrogram 800 to the corresponding position of the Mel-spectrogram 810, and generates a stitched spectrum image 820. After that, the method for identity verification of the present disclosure displays the stitched spectrum image 820 in a user interface for comparison and confirmation by the healthcare worker.

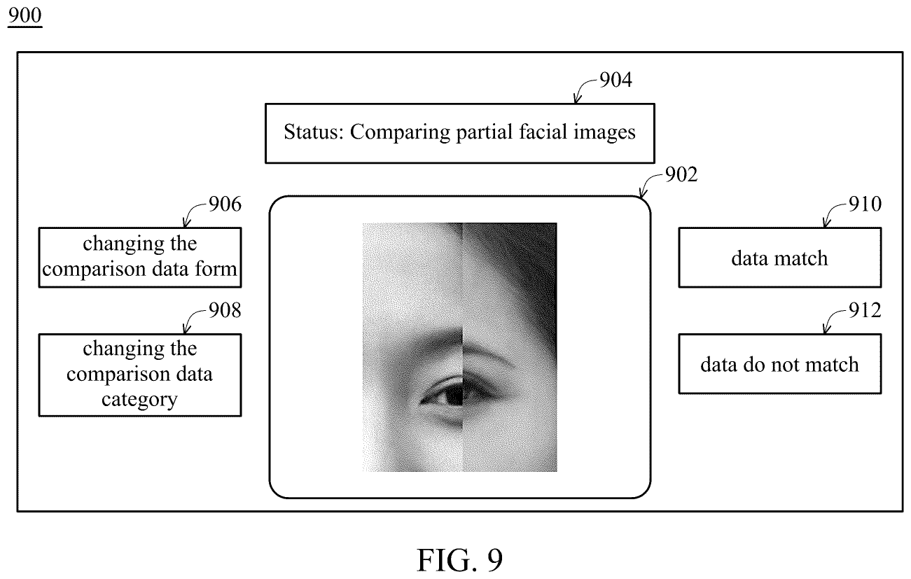

FIG. 9 is a schematic diagram of a user interface 900 in accordance with some embodiments of the present disclosure. The method for identity verification of the present disclosure performs step S108 and step S110 in FIG. 1 through the user interface 900. As shown in FIG. 9, the user interface 900 includes a display window 902, an indication object 904, a control object 906, a control object 908, a judgment object 910, and a judgment object 912. The display window 902 is used to display the real-time low-sensitivity information and at least some initial low-sensitivity information in step S110 in FIG. 1. For example, the display window 902 can display translucent overlapping images of the handwriting 600 and the handwriting 610 in FIG. 6. In some embodiments, the display window 902 can display the stitched face image 720 in FIG. 7. In some embodiments, the display window 902 can display the stitched spectrum image 820 in FIG. 8. The indication object 904 is used for indicating the information pertaining to the image being displayed in the display window 902. For example, if the display window 902 displays the stitched face image 720 in FIG. 7, the indication object 904 may display “Status: Comparing partial facial images”. In some embodiments, If the display window 902 displays the translucent overlapping images of the handwriting 600 and the handwriting 610 in FIG. 6, the indication object 904 may display “Status: Comparing handwriting”. In some embodiments, if the display window 902 displays the stitched spectrum image 820 in FIG. 8, the indication object 904 may display “Status: Comparing Mel-spectrogram”.

In some embodiments, the control object 906 is used to perform the operation of changing the comparison data form. For example, please refer to FIG. 7 and FIG. 9 at the same time. When the display window 902 displays the stitched face image 720 in FIG. 7, the control object 906 is pressed, the method for identity verification of the present disclosure performs horizontally cropped image stitching on the face image 700 and the face image 710, and displays another stitched facial image (not shown) based on the horizontally cropped image stitching in the display window 902. In some embodiments, please refer to FIG. 8 and FIG. 9 at the same time. When the display window 902 displays the stitched spectrum image 820 in FIG. 8, the control object 906 is pressed, the method for identity verification of the present disclosure performs vertically cropped image stitching on the Mel-spectrogram 800 and the Mel-spectrogram 810, and displays another stitched spectrum image (not shown) based on the vertically cropped image stitching in the display window 902.

In some embodiments, the control object 908 is used to perform the operation of changing the comparison data category. For example, please refer to FIG. 7, FIG. 8, and FIG. 9 at the same time. When the display window 902 displays the stitched face image 720 in FIG. 7, the control object 908 is pressed, the image being displayed in the display window 902 may switch from the stitched face image 720 to the stitched spectrum image 820 in FIG. 8, or switch from the stitched face image 720 to the translucent overlapping image of the handwriting 600 and the handwriting 610 in FIG. 6, but the present disclosure is not limited thereto. In other words, if the healthcare worker cannot confirm whether the two are the same person after viewing the comparison image being displayed in the current display window 902, the healthcare worker can press the control object 906 and the control object 908 in the user interface 900 to change the data form and data category of the comparison image.

In some embodiments, the judgment object 910 is used for performing the action of judging that the data is consistent. For example, if the healthcare worker judges that the two stitched face images 720 in FIG. 7 are the same person, the healthcare worker presses the judgment object 910, the processor may receive a control signal from the user interface 900 to confirm that the face image 700 matches the face image 710. In some embodiments, if the healthcare worker judges that the two handwritings of the translucent overlapping image in FIG. 6 are the same, the healthcare worker presses the judgment object 910, the processor may receive a control signal from the user interface 900 to confirm that the handwriting 600 matches with the handwriting 610. In some embodiments, if the healthcare worker judges that the two spectra of the stitched spectrum image 820 in FIG. 8 are the same, the healthcare worker presses the judgment object 910, the processor receives a control signal from the user interface 900 to confirm that the Mel-spectrogram 800 matches with the Mel-spectrogram 810.

In some embodiments, the judgment object 912 is used for performing an action of judging that the data does not match. For example, if the healthcare worker judges that the two stitched face images 720 in FIG. 7 are different people, then the healthcare worker presses the judgment object 912, the processor may receive a control signal from the user interface 900 to confirm that the face image 700 does not match the face image 710. In some embodiments, if the healthcare worker judges that the two handwritings of the translucent overlapping image in FIG. 6 are different, the healthcare worker presses the judgment object 912, the processor receives a control signal from the user interface 900 to confirm that the handwriting 600 does not match with the handwriting 610. In some embodiments, if the healthcare worker judges that the two spectra of the stitched spectrum image 820 in FIG. 8 are different, the healthcare worker presses the judgment object 912, the processor receives a control signal from the user interface 900 to confirm that the Mel-spectrogram 800 does not match with the Mel-spectrogram 810.

While embodiments of the present disclosure have been described above, it should be understood that the foregoing has been presented by way of example only, and not limitation. Many changes of the above exemplary embodiments according to this embodiment can be implemented without departing from the spirit and scope of the disclosure. Therefore, the breadth and scope of the present disclosure should not be limited by the above-described embodiments. Rather, the scope of the present disclosure should be defined by the following claims and their equivalents. Although the above disclosure has been illustrated and described by one or more pertinent implementations, equivalent alterations and modifications may occur to others familiar with the art in light of the above specification and drawings. Furthermore, although a particular feature of the disclosure has been demonstrated in relation to one of its implementations, the aforementioned feature may be combined with one or more other features as may be required and useful for any known or particular application.

The terminology used in this specification is for the purpose of describing particular embodiments only, and is not intended to be used as a limitation of the present disclosure. Unless the context clearly indicates otherwise, as used herein in the singular, the meanings of 1, this and the above also include the plural. Furthermore, the words “comprise”, “include”, “having”, “have”, or their variants are used either as a detailed description or as a scope of patent application. However, the above words are meant to include, and to some extent, are meant to be equivalent to the word “comprising”. Unless otherwise defined, all terms (including technical or scientific terms) used herein can be commonly understood by persons of ordinary skill in the above-disclosed technologies. We should be more aware that the above terms, as defined in commonly used dictionaries, should be interpreted as having the same meaning in the context of the relevant technologies. Unless expressly defined herein, the above terms are not to be interpreted in an idealized or overly formal sense.

1. A method for identity verification, wherein at least some initial low-sensitivity information about a person is stored in a database, comprising:
obtaining the identity of the person;
searching for the initial low-sensitivity information associated with the person from the database based on the identity of the person;
obtaining biological signal data from the person according to data category of the initial low-sensitivity information associated with the person;
sampling and performing dimension reduction on the biological signal data from the person to generate real-time low-sensitivity information associated with the person;
determining the data category and a data form for comparing the real-time low-sensitivity information with the initial low-sensitivity information; and
graphically displaying the real-time low-sensitivity information and the initial low-sensitivity information corresponding to the data category and the data form.

2. The method as claimed in claim 1, further comprising:
obtaining a candidate list for matching the identity of the person; and
receiving a control signal to select the person from the candidate list.

3. The method as claimed in claim 1, further comprising:
receiving a control signal to confirm that the real-time low-sensitivity information matches the initial low-sensitivity information.

4. The method as claimed in claim 1, wherein the data category comprises face images, voiceprints, palm prints, and handwriting.

5. The method as claimed in claim 4, wherein when the data category is face images, the step of sampling and performing dimension reduction on the biological signal data from the person comprises:
utilizing a facial feature detector to capture multiple feature points in the face images;
carrying out cutting according to the distribution of the feature points;
leaving a portion of the feature points corresponding to a part of the face; and
capturing and storing the part of the face in a face image and the portion of the feature points corresponding to the part of the face.

6. The method as claimed in claim 4, wherein when the data category is voiceprints, the step of sampling and performing dimension reduction on the biological signal data from the person comprises:
utilizing a microphone to receive an audio signal from the person;
performing a Fourier transform on the audio signal to obtain an audio spectrum;
taking the logarithm of the audio spectrum and performing an inverse Fourier transform on the audio spectrum to generate a Mel-spectrogram; and
capturing and storing a portion of spectrum information from the Mel-spectrogram.

7. The method as claimed in claim 4, wherein the data form comprises translucent overlapping, vertically cropped image stitching, and horizontally cropped image stitching.

8. The method as claimed in claim 7, wherein when the data category is handwriting, the method further comprises:
performing the translucent overlapping on the real-time low-sensitivity information and the initial low-sensitivity information.

9. The method as claimed in claim 7, wherein when the data category is face images, the method further comprises:
performing the vertically cropped image stitching on the real-time low-sensitivity information and the initial low-sensitivity information.

10. The method as claimed in claim 7, wherein when the data category is face images, the method further comprises:
performing the horizontally cropped image stitching on the real-time low-sensitivity information and the initial low-sensitivity information.
